(19) United States
(12) Patent Application Publication
(10) Pub. No.: US 2001/0056533 A1
(43) Pub. Date: Dec. 27, 2001

(54) Secure and open computer platform

(76) Inventors: Peter Yianilos, Princeton, NJ (US); Joseph Kilian, Princeton Junction, NJ (US)

Correspondence Address: Stephen M. Chin, Esq., Reed Smith LLP, 375 Park Ave, 17th Floor, New York, NY, 10152, US

(21) Appl. No.: 09/887,599

(22) Filed: Jun. 22, 2001

Related U.S. Application Data
(60) Provisional application No. 60/213,495, filed on Jun. 23, 2000.

(51) Int. Cl. G06F 11/30; H04L 9/00

(52) U.S. Cl. 713/153; 713/187; 713/189; 713/201

(57) ABSTRACT

A computer platform is described that provides control features to allow for the protection of intellectual property rights and prevent malfunctioning of the platform. The platform uses 1) a secure operating system including a secure memory management system, 2) public key encryption, 3) data authentication through digital signatures and 4) application/data approval through a flexible access policy through the use of object handlers and an application program approval process. Through these four control features, the platform provides the ability to control access to data and minimize the effects of computer malfunctions.

This application claims the benefits of U.S. Provisional Application Ser. No. 6/213,495 filed Jun. 23, 2000.

### BACKGROUND

1. Field of Invention

This invention relates to an apparatus and system for providing a computer platform, in particular, one that controls the operation of the application programs and object files to adequately protect against computer malfunctions and safeguard the intellectual property rights of the application programs and files.

2. Description of the Related Art

In creating a computer platform, one concern is the amount of control that the platform retains over how application programs operate and data files are accessed on the platform. A computer platform can have control features that implement rules and restrictions on how application programs run and data files are accessed on that platform. Each application program operating on this platform would then usually be written in accordance with these rules or restrictions.

Control features of a platform are intended to effect some type of security to the platform user and/or the application program or object file writer. For example, a computer platform can contain certain control features to prevent undesirable computer malfunctions such as ones caused by a computer virus or a badly written application program. In other instances, a computer platform can also have control features to prevent violations of a person's intellectual property rights that can occur by unauthorized duplication of copyrighted material.

The more control features that are implemented in a given platform, the less flexible the platform is in accommodating application programs. If an application program is written to comply with a particular platform's rules, that application program might only be capable of being used on that platform. Conversely, application programs written to comply with a different platform's rules might not operate on this platform.

An application programmer will usually have to determine which platform the program application is being written for before writing the application program. Consequently, an application programmer will usually favor the platforms that are the least restrictive because it increases the chance of the application program being able to be run on the most platforms. Thus, it is more advantageous for a platform to use the least amount of rules in implementing the desired control features.

If a computer platform is intended to handle sensitive copyrighted material, then prevention of unauthorized copying becomes paramount and other control issues are less important. With the advent and popularity of digital publications and electronic distribution of publications to be read on electronic readers, protection of copyrights on a computer platform has become important.

Consequently, it would be advantageous to provide a computer platform that provides control features to prevent unwanted violations of intellectual property rights and still allows enough flexibility for application programs and object files. It would also be advantageous to provide a computer platform that provides control features that protect against malfunctions of program applications on the platform.

### SUMMARY OF THE INVENTION

The current invention involves a system that provides enough control features to create a secure platform and yet maintain the flexibility to be able to operate and run a large variety of applications.

The invented system entails utilizing four control features which in combination protects against malfunctions in a computer platform and provides the ability to prevent unauthorized access to copyrighted material. These security measures are:

1) A secure operating system, including a secure memory management system;

2) Public key encryption;

3) Data authentication through digital signatures; and

4) Application program/object file approval.

Providing a secure operating system entails two aspects: 1) ensuring that the operating system is approved for the platform and 2) creating firewalls around application programs and object files that operate on the platform. The term firewall is used herein to refer to the arrangement in the computer platform that employs certain memory management components of the operating system to bar access to an application program or an object file in memory. Access to the object file or application program can be granted only if the required permission is obtained.

Encryption generally entails reformatting data using an “encryption” key such that no one else will be able to utilize or read that data if they do not have an appropriate “decryption” key.

Data authentication entails the ability of verifying the author and title of data to ensure that the data is properly authored and has not been tampered with from the time of creation by that author to the receipt by the platform.

Application/data approval allows application programs to reject the type of object files that it will operate on and also allows the object files to reject the application through a flexible access policy through the use of object handlers and an application program approval process.

In the invented system, these four types of control features are available to be accessed by an application program or data file while on the platform. Application programs and files can operate on the platform without utilizing the control features. Through these four types of control features, a computer platform that is both open to accept various application programs and to protect intellectual property is provided.

### BRIEF DESCRIPTION OF THE DRAWINGS

The accompanying drawings are included to provide an understanding of the invention and constitute a part of the specification.

FIG. 1 depicts the layout of an apparatus that implements one embodiment of the present invention;

FIG. 2 depicts a flow chart demonstrating the creation of a digital signature in accordance with one embodiment of the present invention;

FIG. 3 depicts a flow chart demonstrating the signature authentication process in accordance with one embodiment of the present invention;

FIG. 4 depicts a flow chart demonstrating the creation of a digital signature along with the further step of encryption in accordance with one embodiment of the present invention;

FIG. 5 depicts a flow chart demonstrating the signature authentication process along with the further step of decryption in accordance with one embodiment of the present invention;

FIG. 6 depicts a flow chart demonstrating the creation of a digital signature along with the further step of encryption in accordance with another embodiment of the present invention

FIG. 7 depicts a flow chart demonstrating the signature authorization process along with the further step of decryption in accordance with another embodiment of the present invention; and

FIG. 8 depicts a flow chart demonstrating the steps of obtaining permission to access data in memory in accordance with one embodiment of the present invention.

### DESCRIPTION OF THE INVENTION

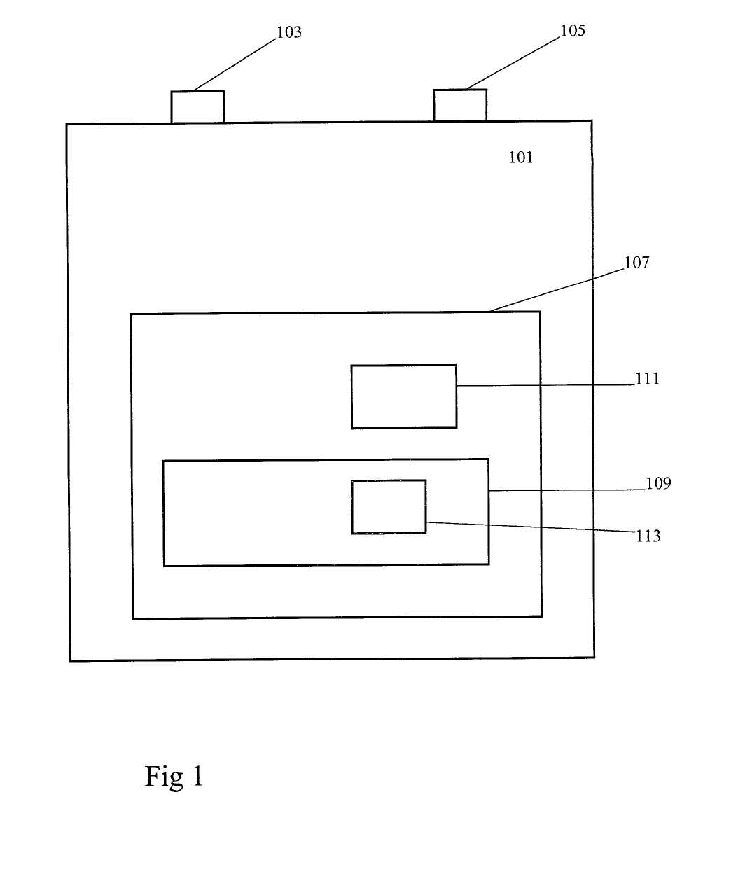

FIG. 1 depicts the layout of a device that implements one embodiment of the present invention. Computer platform 101 is provided with an input interface 103 and an output interface 105 to allow the platform to obtain and transmit data. Input interface 103 and output interface 105 can be the same physical interface so long as it has the capability of both receiving and transmitting data.

Hardware 107 is contained within computer platform 101 and implements firmware 109. Hardware 107 also comprises memory registers 111. The computer platform's operating system will be loaded onto the hardware 107.

The operating system (“O/S”) is the foundation for the platform's security and digital rights management infrastructure. Firmware 109 contains an O/S verifier 113 to authenticate the O/S before the O/S is loaded onto the hardware 107. Every time that the O/S is loaded or modified, the O/S verifier 113 must authenticate the O/S. O/S verification prevents potential circumvention of the security features that are implemented by the O/S by unauthorized modification or substitution of the O/S. O/S verification does not impose any restrictions that would affect application programs running on the computer platform.

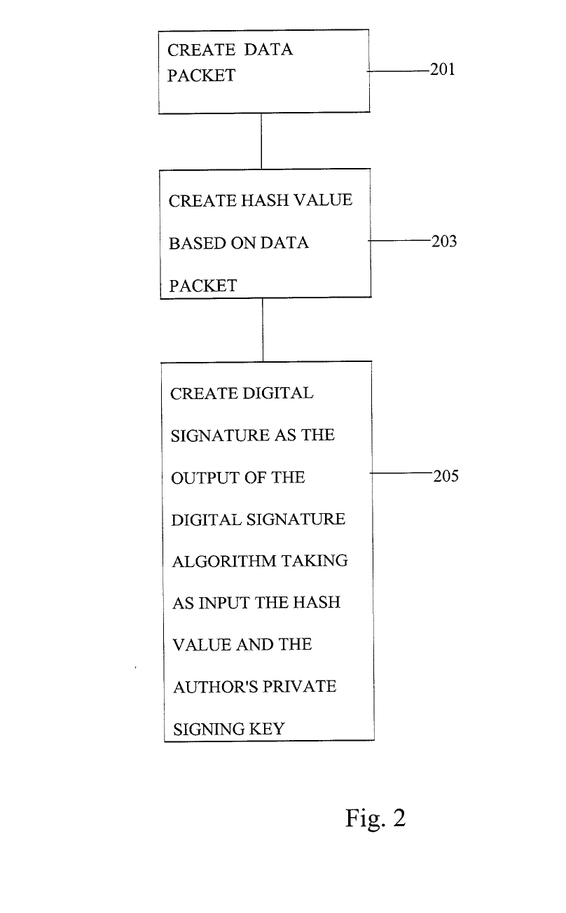

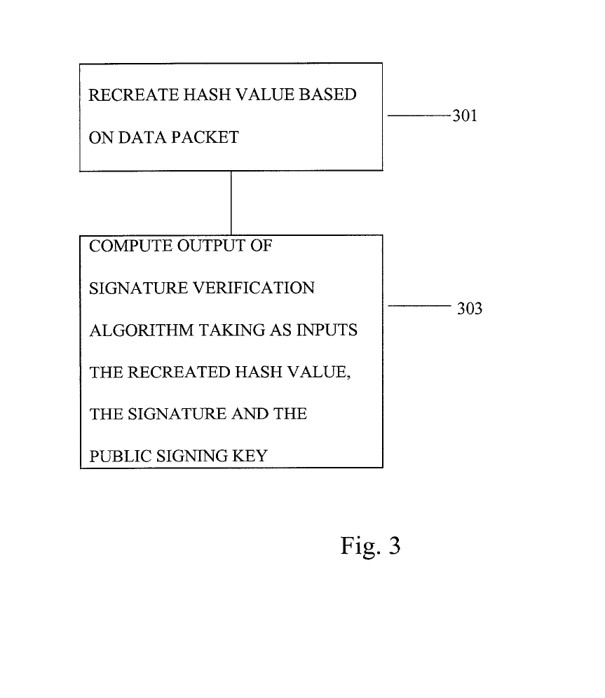

O/S verification can be accomplished by various methods. One method of O/S verification that can be implemented uses digital signatures. Algorithms for creating and verifying signatures, and for generating the public/private signing key pairs, are well known in the literature (c.f. Bruce Schneier, “Applied Cryptography, second edition”, John Wiley & Sons, Inc. New York (1996)). FIGS. 2 and 3 depict digital signature verification for the O/S. This technique uses public/secret signature keys. The first step 201 of the digital signature process is to create the data packet to be signed. The data packet is not necessarily just the O/S. Other information may be included as part of the data packet. For example, the credentials of the data can be included along with the data packet. These credentials can include various items to identify the O/S, such as, the author, version and date of creation.

After determining the data packet to be signed, the next step 203 is to apply a hash function to the data packet. A hash function essentially creates a value of fixed length called the hash value. The hash value is derived from characteristics of the data packet. Different data packets will usually create different hash values. Furthermore, it is computationally unfeasible to produce two different packets that have the same hash value.

Each author is associated with one or more public/private pairs of signing keys. After the hash value is created (203), the hash value and the private signing key are input to a fixed, publicly known signing algorithm, that produces a digital signature as its output (205). Each private signing key is unique to and known by a single author. The resulting signature is unique to the author who knows the private signing key.

FIG. 3 depicts the steps that are taken to authenticate a signed data packet. The first step (301) is to recalculate the hash value of the data packet. This calculation reapplies the hash function to the data packet. The recalculated hash value, the signature and the public signing key are given as inputs to a fixed, publicly known signature verification algorithm (303). This algorithm outputs one of two values: “accept”, meaning that the signature is to be accepted and “reject”, meaning that the signature is to be rejected.

The combination of creating a hash code and signing the hash code to create the digital signature allows the ability of ensuring that the signer created the signature and that the data packet has not been altered since the signature was created.

For the O/S verifier, the authorized O/S programmer's public signature key is burned into the hardware of the computer platform. This is necessary since the O/S is usually the first software that is loaded onto the computer platform and the computer platform must be able to verify that O/S when it is loaded. The authorized O/S programmer is usually the manufacturer of the computer platform.

The procedures of creating a digital signature and authenticating the digital signature detailed in FIGS. 2 and 3 are not limited to O/S verification. These procedures can also be applicable to the process of authenticating application programs and object files. However, in addition to the procedures in FIGS. 2 and 3, authenticating application programs and object files can entail additional steps.

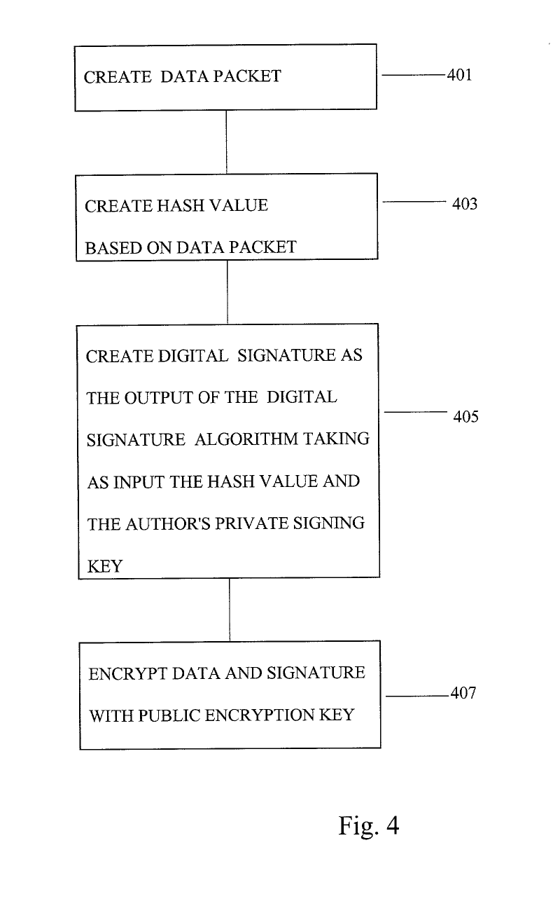

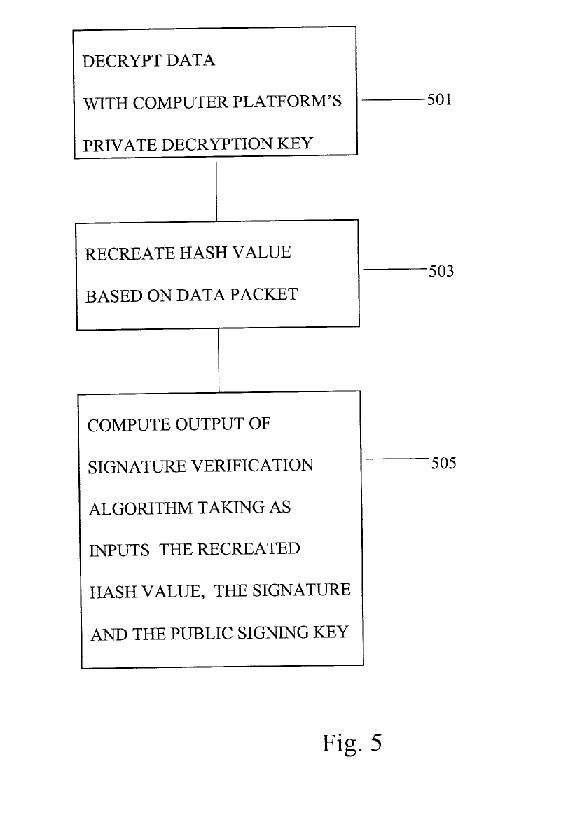

FIGS. 4 and 5 depict the procedures that can be implemented when authenticating signatures of application programs and object files. Similar to the procedures outlined in FIG. 2, the first three steps of creating a signature for application programs and object files are the steps of creating the data packet 401, creating the hash value 403 and creating the digital signature 405. For application programs and object files, credentials should be included with the data packet and those credentials should include at least the name of the author of the data. After the signature of the data packet is created, the data packet and the signature are both encrypted with a public encryption key in step 407.

Similar to the public/secret signature keys, the public encryption key is distinctively related to a private decryption key. However, both encryption/decryption keys are unique to a particular computer platform rather than a particular programmer. Another difference is that the public encryption key is used to encrypt the data while the private decryption key is used to decrypt the data. The private decryption key is kept secret and is only known to that particular computer platform. This permits only that computer platform access to the encrypted data that has been encrypted with the public key unique to the platform.

To authenticate the application program or object file, the first step 501 is to decrypt the encrypted data with the computer platform's private decryption key. After the data has been decrypted, the decrypted data should consist of the data packet and the digital signature. The next steps are to recreate the hash value of the data packet 503, and obtain the output from the publicly known signature verification algorithm 505. If the hash values do not match, then the data is erased from memory.

Encryption of the data packet by using the public/private key technique provides rigorous protection against unauthorized access to the encrypted data by using two separate keys. This process, however, can utilize a substantial amount of the platform's processing resources. In addition, by encrypting the entire data packet, the encryption and decryption process can take a substantial amount of time to perform.

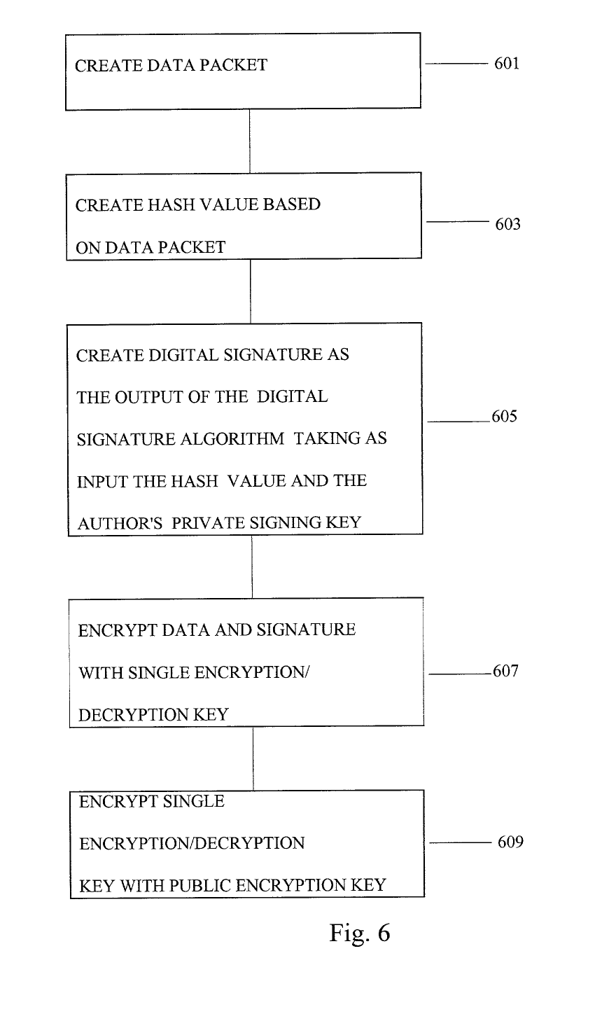

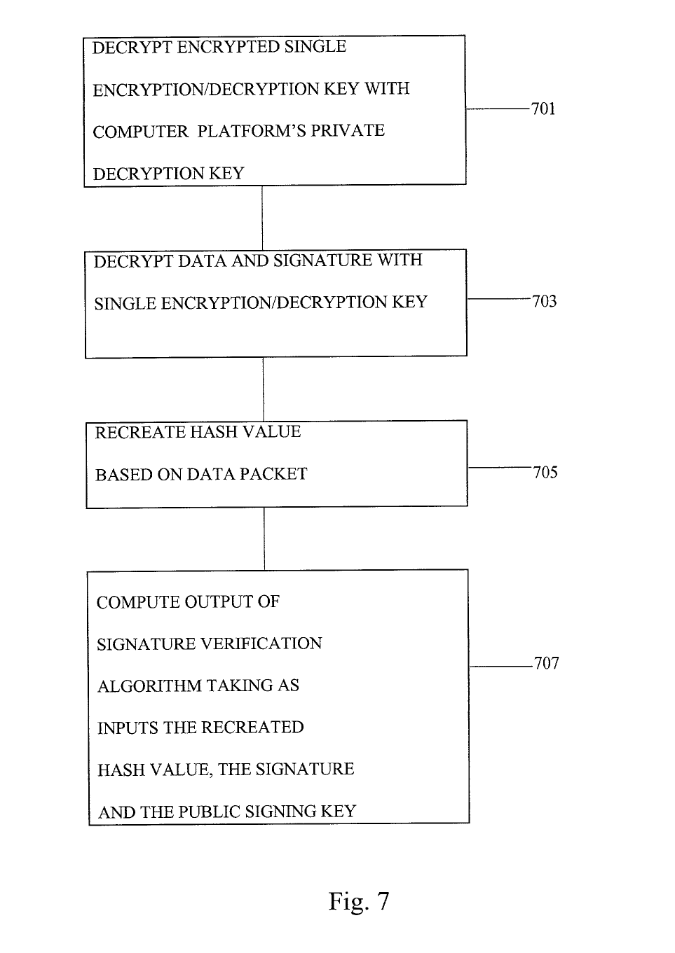

Another alternative to using the public/private keys to encrypt the data packet is to utilize a less complicated encryption technique in addition to the public/private key encryption. FIGS. 6 and 7 depict the process of authenticating program applications and object files utilizing the second encryption technique.

The first step 601 is to create the data packet. The second and third steps 603, 605 are to create the hash value and digital signatures of the data packet. The fourth step 607 is to encrypt the data packet and signature with a single encryption/decryption key. This single key is used to both encrypt and decrypt. The single decryption key, itself, is then encrypted in the next step 609 with the public encryption key that pertains to the particular platform.

To decrypt the data at the platform, the platform will first have to decrypt the single encryption/decryption key by using its private decryption key in step 701. With the decrypted single encryption/decryption key, the platform now has the single encryption/decryption key and the data packet can then be decrypted. By separately encrypting the single encryption/decryption key with the public/private keys, the benefit of using the more secure public/private encryption system to protect the entire data packet is gained while maintaining a lower level of complexity.

Once an application program or object file has been authenticated by the procedures detailed in FIGS. 4 or 6 or other similar procedures, it is considered to be secure data. If an application program or object file is not authenticated, it is considered to be insecure.

By having the encryption/decryption keys unique to each computer platform, the invented system can restrict the availability of data to a particular computer platform. Any computer platform that does not have the correct private decryption key for an encrypted data packet cannot properly decrypt it. This ability, in combination with the signature authentication procedures, provides the ability to exert complete control over data transmissions to the computer platform by: 1) ensuring that any data transmission to the computer platform can only be read by that platform, and 2) ensuring that the data transmission has not been tampered with since the author of the data signed it.

The computer platform's private decryption key must be burned into the hardware so that the platform will always be able to decrypt encrypted data packets. In addition, authentication of application programs and object files should be done every time that an application program or object files is placed into the computer platform's memory. By performing this authentication every instance that data is loaded onto the platform, the system ensures that all data loaded on the computer platform will be properly characterized as either secure or insecure.

Although only the manufacturer's public signature is burned into the hardware, the ability to designate application programs and object files as being secure is not restricted to the manufacturer of the computer platform. Any programmer that writes an application program or object file to be used on the computer platform can designate it as being secure data. To accommodate different programmers in designating data as secure, the programmers can send all data to be designated as secure to the manufacturer. After authenticating the data from the programmer, the manufacturer will then digitally sign the data with its secret signature key that corresponds to the public signature key that has been burned into the computer platform's hardware.

Another embodiment entails sending the application programmer's public signature key to the manufacturer. The manufacturer can then digitally sign this public signature key. This signature can then be appended to signatures using the application programmer's signature key. Since it has been signed by the manufacturer, the computer platform will accept the programmer's public signature key as an additional signature key that can be used to authenticate application programs and object files as being secure. These additional public signature keys and the corresponding identities are stored in a list by the O/S. This list will be accessed by the O/S and the identity contained in the credentials will be used to determine the appropriate public signature key.

This procedure of approving another programmer's public signature key is not applicable to O/S verification. It is important to always control the O/S because it ensures that the security features imposed by the O/S cannot be circumvented.

One security feature implemented by the O/S that should not be circumvented is creating firewalls around data in the memory registers 111 to preserve the integrity and privacy of the application programs and the object files. Both an application program's memory and an object files' memory are automatically shielded from all other applications that may be running on the computer platform 101. No special programming by the programmers is needed to enjoy this protection. To breach a firewall, the O/S will seek permission from two places: 1) the application program requesting the breach and 2) the data in memory that is to be accessed.

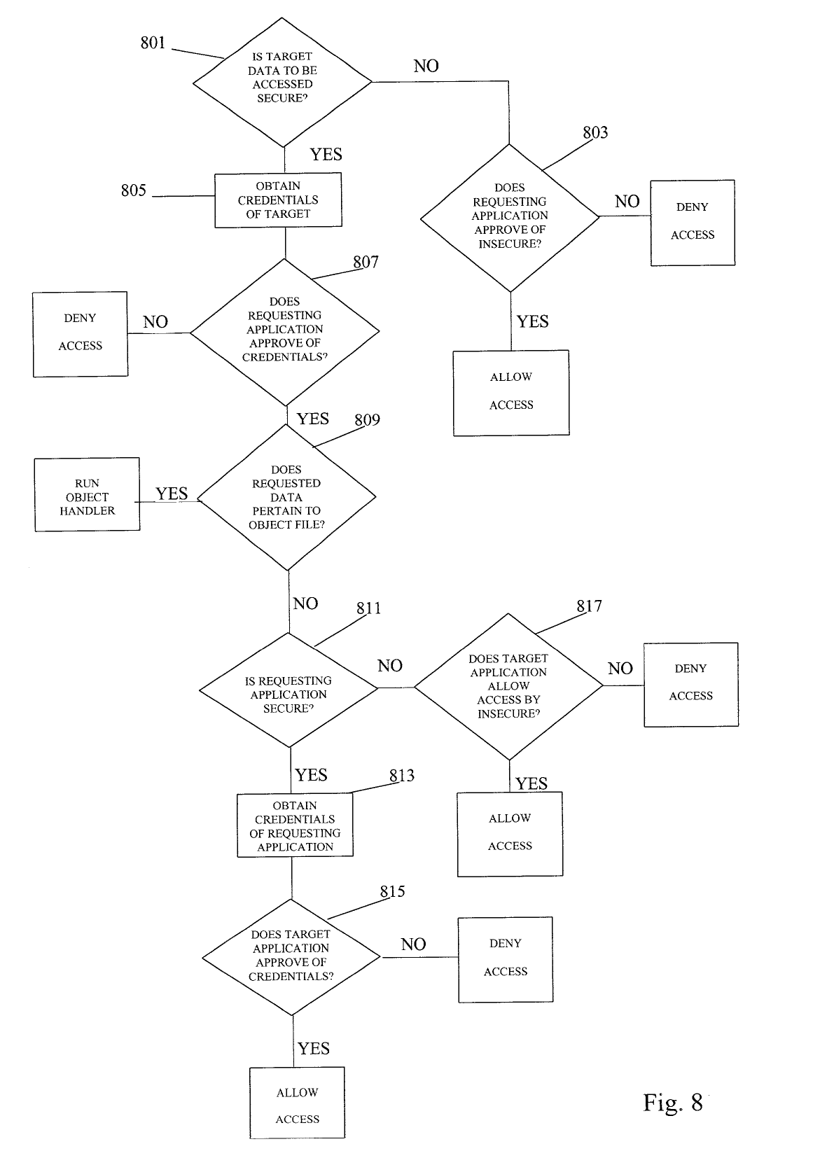

FIG. 8 depicts the process of obtaining the appropriate permission before allowing access to application programs or object files in memory. For the first step 801, the O/S determines if the data in memory to be accessed belongs to a secure object file or application program. If the data in memory is not secure, then the O/S informs the requesting application program that it is not secure. The O/S will permit the requesting application program to gain access to the insecure data if the requesting application has been written to allow access to insecure data as determined in step 803.

If the data in memory pertains to secure data, then the. O/S provides the credentials of the secure target data to the requesting application program in step 805 in order for the requesting application program to determine if the credentials are approved in step 807.

The O/S will not automatically provide access to the secure data if the requesting application program approves of the credentials. With secure data, the O/S then determines whether the data pertains to an application program or an object file in step 809.

If the memory belongs to an object file, then the O/S will usually run an object handler associated with the object file. The term “object handler” used herein refers to a program that is associated with object files that determine if access to that object file is permitted. For example, an object handler associated with a particular object file might permit access through the fire wall for an application program which derives from the publisher of the object file. The object handler can use a number of parameters (publisher, expiration date, platform identifications, etc.) as criteria for access. If the object handler determines that permission to access the desired memory is permitted, the O/S will allow access.

Object handlers are usually created by the author of the data packet and are included along with the data packet that will be digitally signed. However, default object handlers can created by the O/S for secure object files that have no object handler in another embodiment of the present invention.

If the target data in memory belongs to an application program, then the O/S must then determine if the target application approves of the requesting application program. The next step 811 is to determine if the requesting application is secure. Depending on the requesting application's secure status, either the credentials of the requesting application is communicated to the target application program in step 813 or the fact that it is insecure is communicated to the target application program. In either case, the target program application must determine if access to its memory is granted as depicted in steps 815 and 817 respectively.

Obtaining permission to breach a firewall must be obtained every new instance in which an application program requests access to data in memory. Once an application program obtains permission to access the memory, the application program does not have to obtain permission again until it terminates its access. Once access is terminated, a successive request for access to data in memory will treated as a new instance and the requisite permission must be obtained.

By rigorously protecting the integrity of application programs and object files in memory, the system minimizes the damage caused by computer malfunctions. Any malfunctioning application program or computer viruses can be blocked from affecting other program applications and object files. The firewall essentially isolates potential adverse effects to application programs and object files.

Firewalls also allow the system to extend the control over data transmissions exerted through data encryption and signature authentication to cover the data while in the computer platform's memory. Once in the computer platform's memory, unauthorized access is blocked by the combination of the firewalls and the approval process through object handlers and application program approvals. Thus, unauthorized access to the data is prevented from the time of the creation of the digital signature through to the transmission of the data to the computer platform and use on the platform.

Unauthorized access to the data can also be prevented when the data is exported out of the computer platform by applying the encryption/decryption process to all data being transmitted out of the computer platform. Every time that any data marked as secure is transferred out of the computer platform, the computer platform encrypts the data with the computer platform's encryption key. By encrypting the data, this prevents anyone who does not have that computer platform's decryption key from improperly accessing the data that has been transferred out of the platform.

A variety of data may be designated as sensitive by the OS, meaning that it is undesirable for other entities to learn the contents of this data. For example, the OS may designate as sensitive data that it receives in encrypted form. The OS may automatically deem portions of the memory used by a secure application to be sensitive. Or it may act on a request, generated by an application or the OS itself, that data be designated as being sensitive.

Normally, sensitive data is kept within the computer platform. However, due to memory limitations or to enable backups, it may be necessary to export sensitive data from the computer platform. In the preferred embodiment of the invention, information that is designated as sensitive by the OS is encrypted when it is transmitted, in its entirety or in part, out of the computer platform, and decrypted when it is reimported into the computer platform. In the preferred embodiment of the invention, the OS performs these encryption and decryption steps automatically. Other modes of operation are possible and may be more suitable for specific contexts. For example, the OS may query the computer platform's user or applications residing on the computer platform before performing the encryption or decryption operations.

By controlling access to data that has been transferred out of the platform, the invented system effects control over access to the data in all instances of potential access after the digital signature is created. Besides fraudulently securing permission by accessing the secret and private keys, a person must pass the implemented security measures to gain access to secure data. These security features do not impose restrictive rules upon the application programmer because insecure application programs and object files can still operate on the invented system.

The present invention is not to be considered limited in scope by the preferred embodiments described in the specification. Additional advantages and modifications, which readily occur to those skilled in the art from consideration and specification and practice of this invention are intended to be within the scope and spirit of the following claims:

We claim:

1. A data control system comprising:
a computer platform having hardware; said hardware capable of authenticating an operating system to be loaded on said hardware and preventing said operating system from being loaded onto said hardware when said operating system is not authenticated;
said hardware having memory in which application programs and object files can be stored;
said operating system capable of creating a firewall around data in memory pertaining to application programs and object files to control access to said application programs and object files;
an input interface connected to said platform to allow input data to be received by said platform; said operating system capable of decrypting said input data and of authenticating said input data;
said firewalls around said data in memory being capable of allowing said application programs to access said data in memory when approval of access is obtained from said application program and from said data in memory; and
an output interface connected to said platform to allow said platform to transmit output data out of said platform; said output data being encrypted when transmitted.

2. A data control system as claimed in claim 1, wherein said hardware authenticates said operating system by verifying a digital signature associated with said operating system.

3. A data control system as claimed in claim 1, wherein said operating system decrypts said input data with a private decryption key unique to said platform.

4. A data control system as claimed in claim 1, wherein said operating system authenticates said input data by verifying a digital signature associated with said input data with a public signature key and input data that is not authenticated by said operating system is classified as insecure data.

5. A data control system as claimed in claim 3, further comprising a sending station capable of encrypting data with a public encryption key; said public encryption key being directly related to said private decryption key of said computer platform.

6. A data control system as claimed in claim 4, further comprising a sending station capable of creating a digital signature with a secret signature key; said secret signature key being distinctively associated with said sending station.

7. A data control system as claimed in claim 1, wherein said data in memory gives approval for access through an object handler associated with each of said object files when said data in memory pertains to said object files.

8. A data control system as claimed in claim 1, wherein said output data is encrypted with an encryption key unique to said platform.

9. A data control system as claimed in claim 8, wherein said output data is decrypted with an decryption key associated with said public encryption key.

10. A data control system as claimed in claim 4, wherein said output interface encrypts said output data when said output data includes at least a portion of data that has been authenticated by said operating system.

11. A data control system as claimed in claim 1, wherein said operating system is capable of authenticating said input data by using a hash function.

12. A data control system comprising:
a sending station,
a plurality of receiving platforms, each of said receiving platforms having firmware and an operating system, said firmware authenticating said operating system,
said sending station including: (a) a plurality of application programs, (b) a plurality of object files, (c) a plurality of handler programs, each associated with a separate one of said object files, and (d) a plurality of secret key encoded signatures, each distinctive to a subset of said application programs and said object files,
each of said receiving platforms being adapted to receive said application programs, object files, handlers and signatures,
each of said receiving platforms having: (a) a public signature identification key to authenticate said signatures and (b) firewalls associated with said application programs and object files to control access to each of said application programs and object files,
the one of said handler programs associated with each of said object files permitting access to the associated object files by an appropriate one or more of said application programs.
each of said handler programs being programmable to permit multi-parameter control over access to the associated one of said object files.

13. The data control system of claim 12 wherein: said object files and said application programs at said sending station are encrypted with a public key unique to the receiving platform being addressed and wherein said encrypted object files and application programs are decrypted with a private key, at the receiving platform.

14. The data control system of claim 12 wherein said signature identification is provided through a signature creation algorithm and a secret key at said sending station and through a signature verification algorithm and a public key at each receiving platform.

15. The data control system of claim 13 wherein said signature identification is provided through a signature creation algorithm and a secret key at said sending station and through a signature verification algorithm and a public key at each receiving platform.

16. The system of claim 12 wherein:
said sending station has a plurality of secret key encoded signatures, each signature being distinctive to a separate set of application programs and data texts,
each receiving platform having a plurality of public signature identification keys to correspond to the plurality of secret keys at said sending station.

17. A method for providing a data control system, comprising the steps of:
authenticating an operating system to be loaded on a computer platform; said authenticating step to be performed every time an operating system is loaded on said computer platform;
verifying credentials of data transmitted to said computer platform before loading said data into memory of said computer platform;
creating firewalls around data loaded into memory of said computer platform;
decrypting data transmitted to said computer platform with a private decryption key unique to said computer platform; and
encrypting data transferred out of said computer platform with a public encryption key unique to said computer platform and associated with said public decryption key.

18. A method as claimed in claim 17 wherein said authenticating step is performed by verifying a digital signature associated with said operating system.

19. A method as claimed in claim 17 further comprising the step of obtaining permission before allowing an application program to access data loaded into memory.

20. A method as claimed in claim 19 wherein said obtaining step is performed through object handlers.
